(19) United States
(12) Patent Application Publication
(10) Pub. No.: US 2018/0331965 A1
(43) Pub. Date: Nov. 15, 2018

(54) CONTROL CHANNEL USAGE MONITORING IN A SOFTWARE-DEFINED NETWORK

(71) Applicant: Hewlett Packard Enterprise Development LP, Houston, TX (US)

(72) Inventors: Sebastien Tandel, Santa Clara, CA (US); Julio Correa, Palo Alto, CA (US); Rafael Anton Eichelberger, Porto Alegre (BR)

(21) Appl. No.: 15/755,834

(22) PCT Filed: Aug. 31, 2015
(86) PCT No.: PCT/US2015/047712

§ 371 Date: Feb. 27, 2018

(51) Int. Cl. H04L 12/825; H04L 12/26

(52) U.S. Cl. CPC H04L 47/25; H04L 43/0888; H04L 43/0894

(57) ABSTRACT

In some examples, a Software-Defined Network (SDN) controller includes a processing resource a memory resource including machine readable instructions to: (1) run a first SDN application to monitor usage of a control channel between the SDN controller and a device in the control domain of the SDN controller, (2) run a second SDN application that uses the control channel to communicate with the device, (3) and throttle the use of the control channel by the second SDN application when it is determined, by monitoring usage of the control channel with the first SDN application, that control channel usage satisfies a usage criteria.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices. Some intermediary datapath devices can process data received by the device by modifying metadata information of the data or by copying the data.

### BRIEF DESCRIPTION OF DRAWINGS

FIG. 1 is a diagram of a network, according to an example.

FIG. 2 is a flowchart for a method, according to an example.

FIG. 3 is a flowchart for a method, according to another example.

FIG. 4 is a flowchart for a method, according to another example.

FIG. 5 is a flowchart for a method, according to another example.

FIG. 6 is a diagram of network switch, according to an example.

FIG. 7 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Software-defined networking can allow for the decoupling of traffic routing control decisions (e.g., which port of a network switch should be used to forward traffic en route to a given destination) from the network's physical infrastructure. For example, in a Software-Defined Network (SDN), such traffic routing control decisions can be determined by an entity (e.g., a network controller) that is different from the routing device itself (e.g., the network switch tasked with forwarding the traffic). A network controller used in implementing an SDN (i.e., an SDN controller) can, for example, be programmed to: (1) receive dynamic parameters of the network from intermediary datapath devices (e.g., network switches), (2) decide how to route packets over the network, and (3) inform the devices about these decisions. SDN controllers can, for example, be configured to access and control multiple devices within the SDN via a network communication channel. Such a network communication channel can be referred to as a “control channel,” an “OpenFlow channel” (for SDN's implemented using the OpenFlow protocol), a “communication channel,” an “interface channel,” etc. In some networks, an SDN controller can use such a control channel to configure devices (e.g., configure flows stored on devices), receive data packets, send packets using the device, gather state and statistics from devices, and/or other uses.

In some networks, SDN applications are run on the SDN controller or on other devices on the network (or otherwise in communication with the network) and interfaced with the SDN controller to meet customer use cases, such as to achieve a desired throughput (or another Quality of Service (QoS)) over the SDN, enforce security provisions for the SDN, or provide another suitable service or functionality. Some SDN applications create traffic over the control channel for various uses by the SDN application. For example, some SDN applications are able to configure devices to send data packets to the SDN controller using the control channel. This and other uses of the control channel by SDN applications can be subject to scalability limits and when such a limit is reached data loss along the control channel may occur. For example, in some situations, once a control channel is overloaded, data packets, state, statistics and device configuration sent through the channel by the SDN controller or another device may be lost, which can lead to misconfiguration on devices controlled by the SDN controller. Misconfiguration of devices on the network can in some situations lead to communication issues or other issues.

Certain implementations of the present disclosure are directed to address one or more of the issues described above or other issues. For example, in some implementations, a method can include: (a) monitoring, with an SDN controller, usage of a control channel for the SDN controller and a device in the control domain of the SDN controller and (b) determining, with the SDN controller, whether the monitored usage satisfies a usage criteria. In some example implementations, control channel usage can be continuously monitored and once the usage is determined to be close to a control channel limit, an SDN controller can actively throttle or otherwise control the data packet rate in order to avoid channel overload. For example, in some implementations, the SDN controller can notify SDN applications to stop sending data packets over the control channel or can actively stop the transmission of packets sent by the SDN applications over the control channel during a period of time. Other advantages of implementations presented herein will be apparent upon review of the description and figures.

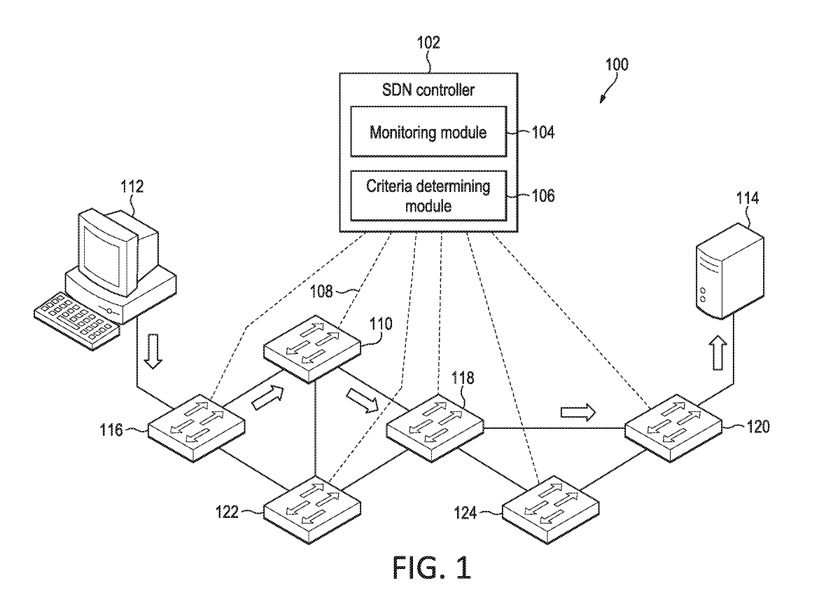

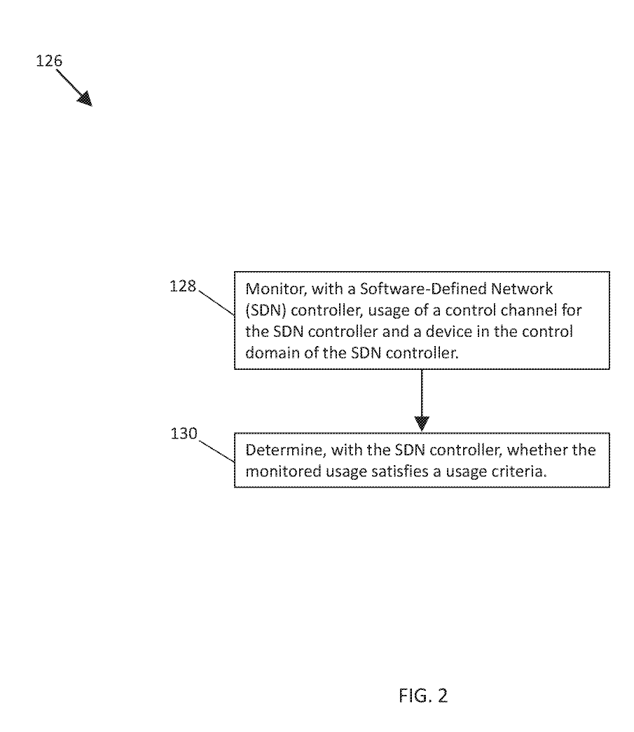

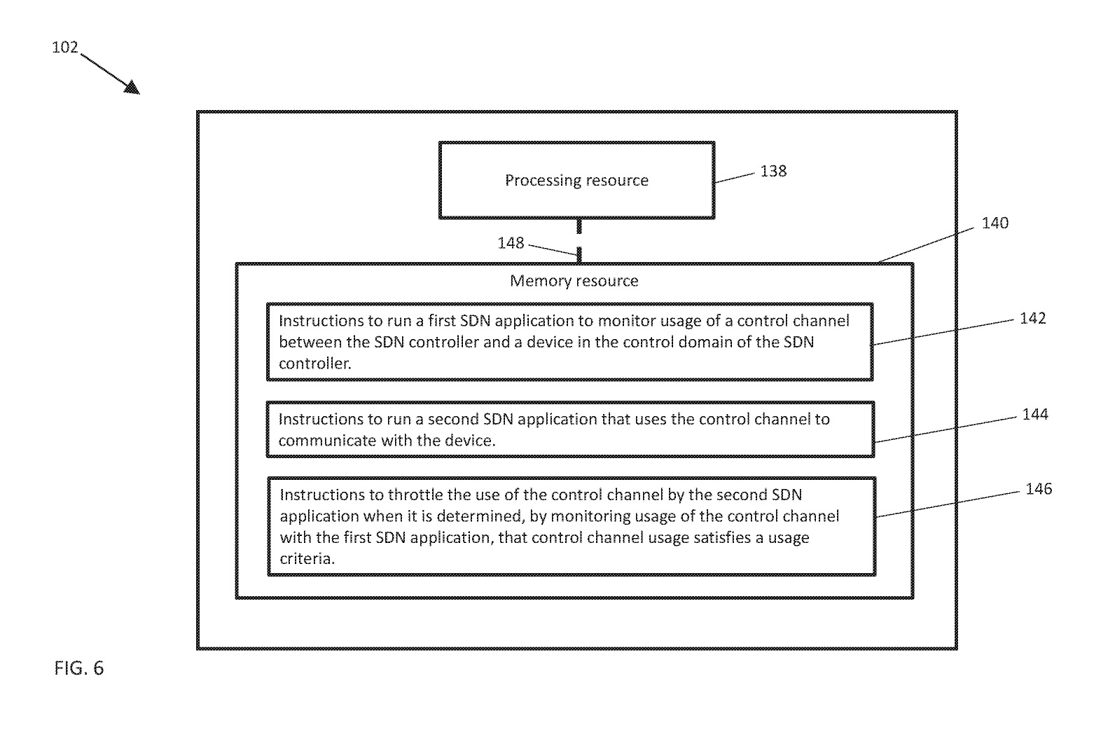

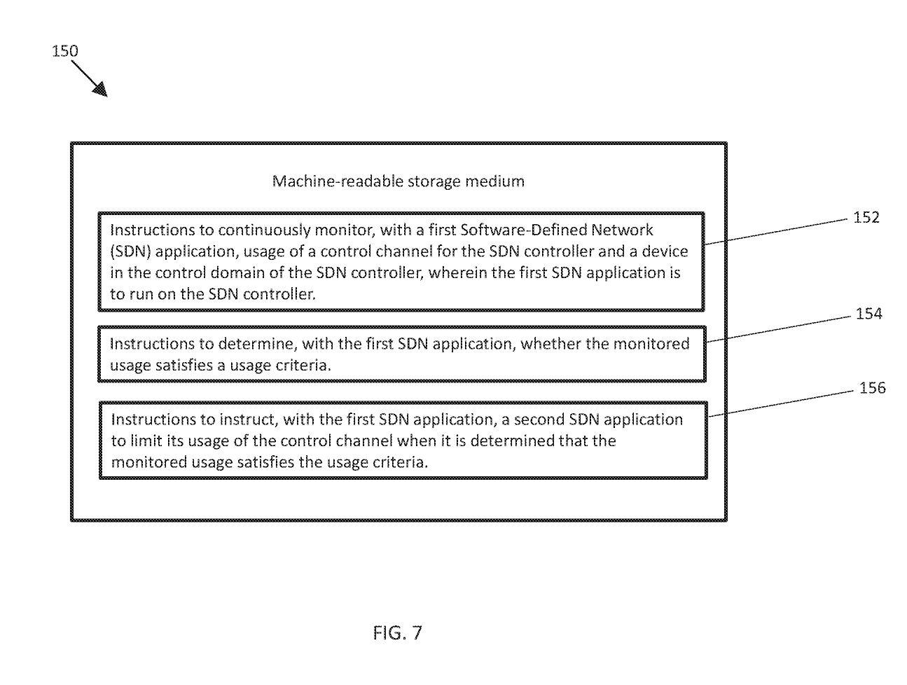

FIG. 1 is a diagram of an example software-defined network (SDN) 100 including an example SDN controller 102 including various combined hardware and software modules 104 and 106 as well as various control channels between various network nodes in SDN 100. An example control channel 108 between SDN controller 102 and switch 110 will be referred to throughout this disclosure for consistency. It is appreciated that references herein to a control channel can apply to suitable control channels between SDN controller 102 and other network nodes. The structure and functionality of the various modules of SDN controller 102 are described in detail below with respect to the methods of FIGS. 2-5, the SDN controller of FIG. 6, and the medium of FIG. 7.

FIG. 1 depicts network traffic along a datapath between an example source node 112 and example destination node 114, the datapath being defined by network nodes 116, 110, 118 and 120. Other network nodes, such as nodes 122 and 124 can be included within SDN 100 but are not used in this datapath. It is appreciated that the datapath can be determined by SDN controller 102 (or another entity, such as by a network administrator, by datapath nodes themselves, etc.) based on one or more static parameters (e.g., link speeds, number of hops between nodes, etc.) and can further (or alternatively) be based on one or more dynamic parameters (e.g., QoS, network latency, network throughput, network power consumption, etc.)

As provided above, network nodes within SDN 100 can forward traffic along a datapath based on metadata within the traffic. For example, traffic in the form of a packet can be received at network switch 110 (or another suitable intermediary network node). For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist the network node with reliably delivering payload data. For example, control data can include network addresses for source node 112 and destination node 114, error detection codes, sequencing information, packet size of the packet, a time-to-live (TTL) value, etc. In contrast, payload data can include data carried on behalf of an application for use by source node 112 and destination node 114.

As provided above, in an SDN (such as for example SDN 100), control decisions for routing traffic through the network can be decoupled from the network's physical infrastructure. For example, SDN controller 102 can be used to instruct network nodes to flow traffic along a selected routing path defined by the nodes. In some implementations, these nodes can, for example, be in the form of network switches or other intermediary network devices. The use of such software-defined networking can provide other functionality. For example, and as mentioned above, one or more applications can be installed on or interface with SDN controller 102 to meet customer use cases, such as to achieve a desired throughput (or another QoS) over SDN 100, enforce security provisions for SDN 100, or provide another suitable service or functionality.

The functionality of SDN controller 102 can, for example, be implemented in part via a software program on a standalone machine, such as a standalone server. In some implementations, SDN controller 102 can be implemented on multi-purpose machines, such as a suitable desktop computer, laptop, tablet, or the like. In some implementations, SDN controller 102 can be implemented on a suitable non-host network node, such as certain types of network switches. It is appreciated that the functionality of SDN controller 102 may be split among multiple controllers or other devices. For example, SDN 100 is described and illustrated as including only one SDN controller 102. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control certain SDNs. In such SDNs, a first controller can, for example, control certain network devices while a second controller can control other network devices. In view of the above, reference in this application to a single SDN controller 102 that controls the operation of SDN 100 is intended to include such multiple controller configurations (and other suitable multiple controller configurations).

Source node 112 and destination node 114 can, for example, be in the form of network hosts or other types of network nodes. For example, one or both of source node 112 and destination node 114 can be in the form of suitable servers, desktop computers, laptops, printers, etc. As but one example, source node 112 can be in the form of a desktop computer including a monitor for presenting information to an operator and a keyboard and mouse for receiving input from an operator, and destination node 114 can be in the form of a standalone storage server appliance. It is appreciated that source node 112 and destination node 114 can be endpoint nodes on SDN 100, intermediate nodes between endpoint nodes, or positioned at other logical or physical locations within SDN 100.

The various intermediary nodes within SDN 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “network switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for SDN 100.

In some implementations, a given network switch in an SDN (e.g., switch 110) can rely on flow rules stored on the switch (or otherwise accessible by the switch) for forwarding or otherwise handling traffic. Flow rules can, for example, contain information such as: (1) match fields to match against packets (e.g., an ingress port and specific packet header fields), (2) a priority value for the flow rule to allow prioritization over other flow entries, (3) counters that are updated when packets are matched, (4) instructions to modify the action set or pipeline processing, (5) timeouts indicating a maximum amount of time or idle time before a flow is expired by the switch, and (6) a cookie value which can be used by SDN controller 102 to filter flow statistics, flow modification, and flow deletion.

The various nodes within SDN 100 are connected via one or more data channels, which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts SDN controller 102 as being connected to each network nodes via broken lines, which is intended to illustrate logical control channels (e.g., control channel 108) between SDN controller 102 and respective nodes. However, it is appreciated that SDN controller 102 may be directly connected to only one or a few network nodes, while being indirectly connected to other nodes of SDN 100. As but one example, SDN controller 102 can be directly connected to node 118 via an Ethernet cable, while being indirectly connected to node 110 (e.g., by relying on node 118 as an intermediary for communication with node 110). In such a situation, control channel 108 is a logical channel between SDN controller 102 and node 110 and is formed by a first physical channel (e.g., a first Ethernet cable) that connects SDN controller 102 to node 118 and by a second physical channel (e.g., a second Ethernet cable) that connects node 118 to node 110.

Within the context of an SDN (e.g., SDN 100), controlled network nodes (e.g., switch 110) can be used as sensors in the network as they have information about dynamic network parameters. When polled via standard SDN interfaces the devices can report this information to SDN controller 102. SDN 100 can, for example, be implemented through the use of SDN controller 102 that interfaces with various SDN-compatible devices via a suitable Application Program Interface (“API”) or a suitable SDN protocol (e.g., OpenFlow) or other protocol.

As used herein, the term “controlled” and similar terminology in the context of SDN-compatible network nodes, such as “controlled switches,” is intended to include devices within the control domain of SDN controller 102 or otherwise controllable by SDN controller 102. Such a controlled node can, for example, communicate with SDN controller 102 and SDN controller 102 is able to manage the node in accordance with an SDN protocol, such as the OpenFlow protocol. For example, an OpenFlow-compatible switch controlled by SDN controller 102 can permit SDN controller 102 to add, update, and delete flow entries in flow tables of the switch using suitable SDN commands.

In the example SDN 100 depicted in FIG. 1, the various network nodes are in the form of intermediary nodes (e.g., controlled network switch 110) and host devices (source node 112 and destination node 114). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNs) in which some devices are controlled by an SDN controller (e.g., SDN controller 102) and some devices are not controlled by the SDN controller (e.g., SDN controller 102 or any other SDN controller 102). For example, in some implementations, at least one node (e.g., node 110) along a given datapath is controlled by SDN controller 102 and at least one node along the given datapath (node 120) is not controlled by SDN controller 102.

FIG. 2 illustrates a flowchart for a method 126 according to an example of the present disclosure. For illustration, the description of method 126 and its component steps make reference to example SDN 100 and elements thereof, such as for example SDN controller 102, network switch 110, source node 112, destination node 114, etc., however, it is appreciated that method 126 or aspects thereof can be used or otherwise applicable for any suitable network or network element described herein or otherwise. For example, method 126 can be applied to computer networks with different network topologies than those illustrated in FIG. 1.

In some implementations, method 126 can be implemented or otherwise executed through the use of executable instructions stored on a memory resource (e.g., the memory resource of the SDN controller of FIG. 6), executable machine readable instructions stored on a storage medium (e.g., the medium of FIG. 7), in the form of electronic circuitry (e.g., on an Application-Specific Integrated Circuit (ASIC)), and/or another suitable form. Although the description of method 126 herein primarily refers to steps performed on SDN controller 102 for purposes of illustration, it is appreciated that in some implementations, method 126 can be executed on another computing device within SDN 100 or in data communication with SDN controller 102.

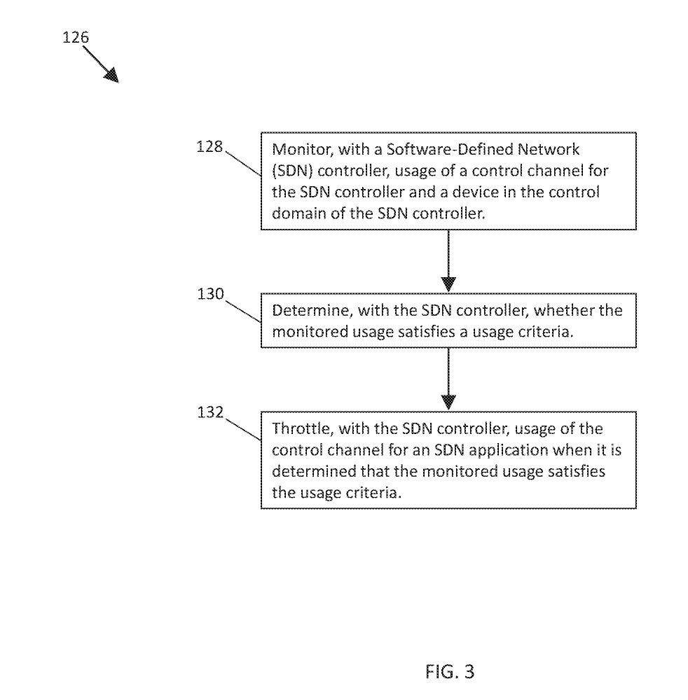

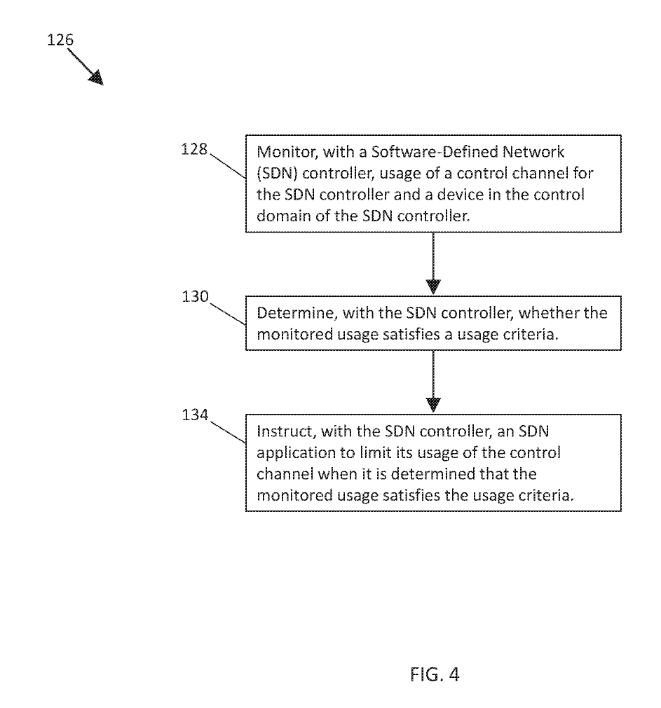

Method 126 includes monitoring (at block 128), with SDN controller 102, usage of control channel 108 for SDN controller 102 and a device in the control domain of SDN controller 102 (e.g., switch 110 for purposes of illustration). The term “monitoring usage” as used herein can, for example, refer to monitoring a rate of data packets (e.g., a number of packets over a period of time), a data transfer rate (e.g., a number of bytes of data over a period of time), or other suitable traffic statistics. For example, such monitoring can include monitoring for bandwidths, latencies, error rates, jitter rates, etc., for data traffic over the network. In some implementations, monitoring can be performed continuously, which can, for example, allow for “real-time monitoring.” Such real-time monitoring can allow for SDN controller 102 to take action (see, e.g., various action steps described below with respect to FIGS. 3-4 and other implementations) based on dynamic parameters within SDN 100. In some implementations, monitoring is not performed continuously and/or can be configured to record data for later analysis or processing by SDN controller 102 or another device.

The term “monitoring” may or may not include the act of “sensing” data within the control channel. That is, in some implementations, SDN controller 102 can be said to monitor usage of control channel 108 based on information sensed by other devices. The information sensed by other devices can be reported to SDN controller 102 for monitoring by SDN controller 102. For example, in some implementations, one or more switches within SDN 100 (e.g., switch 110) can be used as “sensors” in the network as they may have information about dynamic network parameters. When polled via an SDN interface the devices can report this information to SDN controller 102. In such a situation, SDN controller 102 can be said to monitor usage of control channel 108 via information reported by the switches even though SDN controller 102 may not be sensing the data itself. In some situations, SDN controller 102 can also act as a sensor in the network based on dynamic network parameters recorded by SDN controller 102.

Method 126 includes determining (at block 130), with SDN controller 102, whether the monitored usage satisfies a usage criteria. The term “usage criteria” can, for example, be based on a packet rate limit for the control channel, a data rate limit for the control channel, or another suitable usage. For example, in some implementations, the usage criteria can be relevant to a QoS criteria, such as criteria relating to implementing time-sensitive network services, such as high speed computing networks where nodes connect compute servers, real-time multimedia services including Internet Protocol television (IPTV), video calls, online gaming, security camera streams, Voice over IP (VoIP) traffic, or other services. It is appreciated that such usage criteria can, for example, be manually determined by a network administrator or can be statically or dynamically determined by a device in SDN 100, such as SDN controller 102, switch 110, or another computing device.

The term “satisfies a usage criteria” can, for example, refer to monitored usage that is below a threshold value. For example, when usage criteria is based on an upper data rate threshold for the control channel, the monitored usage can satisfy usage criteria when it is below the upper threshold. It is further appreciated that monitored data can satisfy a usage criteria by being above a threshold value. For example, when usage criteria is based on a lower data rate threshold for the control channel, the monitored usage can satisfy usage criteria when it is above the lower threshold. In such an implementation, an event can be generated to notify an SDN application that control channel 108 is ready to be used again.

In some implementations, the usage criteria can be based on a single threshold value, whereas in other implementations, the usage criteria can be based on multiple criteria. For example, in some implementations, monitored usage can satisfy a usage criteria by: (1) being below a threshold value for jitter rate, (2) above a threshold value for packet rates, and (3) within a range of values for data rate. It is appreciated that more complicated criteria can be applied. For example, in some implementations the criteria is satisfied only if the packet rate is less than a threshold value and another condition is satisfied, such as a certain amount of time has elapsed since a starting time.

In some implementations, method 126 can include performing one or more actions based on a determination that the monitored usage satisfies a usage criteria. For example, in some implementations, actions can be performed on the packet level (e.g., when the criteria is satisfied, forward the packet to a given egress port of switch 110 or modify a packet header) or at a higher level (e.g., when the criteria is satisfied, throttle all control channel usage by a given SDN application). In some implementations, actions can be applied for a predefined amount of time (e.g., by associating timers to the action) or a predefined number of bytes (e.g., by associating bytes counters to the action), and/or other conditions. Further description is provided below (e.g., the implementations of FIGS. 3-4) relating to various actions that can be applied once it is determined that the monitored usage satisfies a usage criteria.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 126 or other methods described herein in order to achieve the same or comparable functionality. In some implementations, one or more steps are omitted. For example, in some implementations, block 128 of monitoring control channel usage can be omitted from method 126. It is appreciated that blocks corresponding to additional or alternative functionality of other implementations described herein can be incorporated in method 126. For example, blocks corresponding to the functionality of various aspects of switch 110 otherwise described herein can be incorporated in method 126 even if such functionality is not explicitly characterized herein as a block in a method.

FIG. 3 illustrates another example of method 126 in accordance with the present disclosure. For illustration, FIG. 3 reproduces various blocks from method 126 of FIG. 2, however it is appreciated that method 126 of FIG. 3 can include additional, alternative, or fewer steps, functionality, etc., than method 126 of FIG. 2 and is not intended to be limited by the diagram of FIG. 1 (or vice versa) or the related disclosure thereof. It is further appreciated that method 126 of FIG. 2 can incorporate one or more aspects of method 126 of FIG. 3 and vice versa. For example, in some implementations, method 126 of FIG. 2 can include the additional step described below with respect to method 126 of FIG. 3.

Method 126 of FIG. 3 includes throttling (at block 132), with SDN controller 102, usage of control channel 108 for an SDN application when it is determined that the monitored usage satisfies the usage criteria. As used herein, the term “throttling” can, for example, refer to SDN controller 102 stopping, reducing, or otherwise limiting the transmission of data packets to the control channel by the SDN application. In some implementations, throttling can include slowing of traffic along control channel 108. Such throttling can, for example, be end based on one or more conditions, such as a predefined period of time, until the control channel usage returns to an acceptable level, until a network administrator manually approves the use of the control channel by the SDN application, or another condition. In some implementations, block 132 can include SDN controller 102 instructing the SDN application to reduce its use of control channel 108. In some implementations, block 132 includes throttling usage of control channel 108 by SDN application without the SDN application being informed or otherwise “aware” of such throttling.

FIG. 4 illustrates another example of method 126 in accordance with the present disclosure. For illustration, FIG. 4 reproduces various blocks from method 126 of FIG. 2, however it is appreciated that method 126 of FIG. 4 can include additional, alternative, or fewer steps, functionality, etc., than method 126 of FIG. 2 and is not intended to be limited by the diagram of FIG. 1 (or vice versa) or the related disclosure thereof. It is further appreciated that method 126 of FIG. 2 can incorporate one or more aspects of method 126 of FIG. 4 and vice versa. For example, in some implementations, method 126 of FIG. 2 can include the additional step described below with respect to method 126 of FIG. 4.

Method 126 of FIG. 4 includes instructing (at block 134), with SDN controller 102, an SDN application to limit its usage of the control channel when it is determined that the monitored usage satisfies the usage criteria. In some situations, SDN controller 102 can first instruct (at block 134) SDN application to limit its usage of the control and if this instruction is not performed by the SDN application, then SDN application can proceed to limit the usage of control channel 108 by the SDN application (e.g., via the throttling step of block 132) with or without further informing the SDN application.

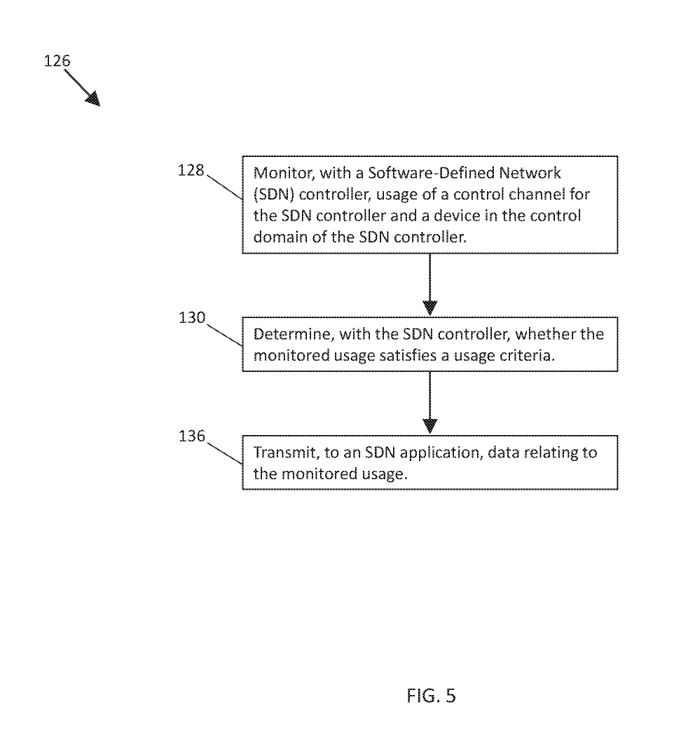

FIG. 5 illustrates another example of method 126 in accordance with the present disclosure. For illustration, FIG. 5 reproduces various blocks from method 126 of FIG. 2, however it is appreciated that method 126 of FIG. 5 can include additional, alternative, or fewer steps, functionality, etc., than method 126 of FIG. 2 and is not intended to be limited by the diagram of FIG. 5 (or vice versa) or the related disclosure thereof. It is further appreciated that method 126 of FIG. 2 can incorporate one or more aspects of method 126 of FIG. 5 and vice versa. For example, in some implementations, method 126 of FIG. 2 can include the additional step described below with respect to method 126 of FIG. 5.

Method 126 of FIG. 5 includes transmitting (at block 136), to an SDN application, data relating to the monitored usage. In some implementations, the transmitted data can be “raw” data recorded by a network node in SDN 100 (e.g., switch 110) and forwarded to SDN controller 102. Such raw data can, for example, include suitable raw values relating to bandwidth, latencies, error rates, jitter rates, etc., for data traffic over control channel 108. In some implementations, the transmitted data can be first processed, aggregated, compared, etc., by SDN controller 102 before being transmitted to the SDN application. For example, in some implementations, data relating to the monitored usage can be an indicator that identifies whether the monitored usage satisfies the usage criteria. That is, the SDN application may only receive a “yes” or “no” answer (e.g., in the form of a bit) as to whether monitored usage satisfies the usage criteria rather than the values used to make the determination. Block 136 of transmitting data related to monitored usage can, for example, be performed by SDN controller 102, another device in SDN 100 (e.g., switch 110), or another suitable device.

A specific example implementation will now be described. It is appreciated that this implementation may include certain aspects of other implementations described herein (and vice-versa), but it is not intended to be limiting towards other implementations described herein. Some example implementations of method 126 can provide for flexible control that allows SDN applications that initially configured devices to send data packets via a control channel (an OpenFlow channel for purposes of this example) to stop sending the packets using event notifications. This example implementation is able to monitor the OpenFlow channel usage and temporarily prevent (by throttling) applications from using the channel to receive data packets (which can, for example, be considered less important than configuration data in certain situations) when the usage is close to the channel limit. The prevention can be done by throttling the OpenFlow channel by the SDN controller itself and without the participation of the SDN application, or with the participation of the SDN application. For the latter option, the SDN controller can use a notification to inform the SDN application that the usage is close to the limit, so that the SDN application can stop using the OpenFlow channel to receive data packets for a short period of time or until the usage decreases to an acceptable level.

In this specific example implementation, real-time monitoring on the OpenFlow channel is provided for usage for each OpenFlow enabled device. This is performed by counting the data packets on the OpenFlow channel using a time slide window counter. The slide window can be split into a number of slots, where the total time for the time window is one second. For example, if the slide window is set with four time slots, each time slot will have 250 milliseconds. When packets arrive, the slot counter will increase. After each 250 milliseconds, counters from all slots will be summed up, the counter on the next slot is reset and the counter is then moved to this next slot. The sum value can represent the number of data packets per second coming via OpenFlow channel and can be sent with the device ID for notification purposes.

In this specific example implementation, once the usage is close to the channel limit, an event is generated that informs which device is close to the usage limit. The SDN application or SDN controller can receive the data packets per second rate and the device ID and it will check if the rate is close to the usage limit for the device OpenFlow channel. If so, a notification event will be generated including the device ID.

In this specific example implementation, throttling can include, as part of usage limit event handling, the stopping of sending of data packets to the OpenFlow channel during a small amount of time or until the channel usage decreases to an acceptable level. More specifically, once a notification event about the channel limit usage is received, one or more SDN applications can be notified about the event, so the applications can configure the devices to stop sending data packets through the OpenFlow channel for small amount of time. Throttling can, in some implementations, include configuring devices to stop sending packets through OpenFlow channel in order to prevent malicious applications from overloading the OpenFlow channel.

In this specific implementation, statistics can be generated for monitored devices that triggered events. For example, notification events can be saved and can be used later to generate statistics per device, so that the network administrator can, for example, know which devices are frequently having OpenFlow channel usage close to the limit.

FIG. 6 is a diagram of an SDN controller 102 in accordance with the present disclosure. As described in further detail below, SDN controller 102 includes a processing resource 138 and a memory resource 140 that stores machine-readable instructions 142, 144, and 146. For illustration, the description of SDN controller 102 of FIG. 6 makes reference to various aspects of the diagram of FIG. 1 as well as method 126 of FIGS. 2-5. Indeed, for consistency, the same reference number for the SDN controller of FIG. 6 is used for the SDN controller of FIG. 1. However it is appreciated that SDN controller 102 of FIG. 6 can include additional, alternative, or fewer aspects, functionality, etc., than the implementation described with respect to method 126 as well as the SDN controller of FIG. 1 and is not intended to be limited by the related disclosure thereof.

Instructions 142 stored on memory resource 140 are, when executed by processing resource 138, to cause processing resource 138 to run a first SDN application to monitor usage of a control channel (control channel 108 in this example) between SDN controller 102 and a device (switch 110) in the control domain of the SDN controller (SDN controller 102 in this example). Instructions 142 can incorporate one or more aspects of blocks of method 126 or another suitable aspect of other implementations described herein (and vice versa). Instructions 144 stored on memory resource 140 are, when executed by processing resource 138, to cause processing resource 138 to run a second SDN application that uses control channel 108 to communicate with switch 110. The second application can, for example, be installed and/or run on SDN controller 102 to meet customer use cases, such as to achieve a desired throughput (or another QoS) over the SDN, enforce security provisions for the SDN, or provide another suitable service or functionality.

Instructions 146 stored on memory resource 140 are, when executed by processing resource 138, to cause processing resource 138 to throttle the use of control channel 108 by the second SDN application when it is determined, by monitoring usage of control channel 108 with the first SDN application, that control channel 108 usage satisfies a usage criteria. In some implementations, memory resource 140 includes machine readable instructions to only throttle the use of the control channel for the second SDN application when the control channel usage satisfies the usage criteria. Instructions 146 can incorporate one or more aspects of blocks of method 126 or another suitable aspect of other implementations described herein (and vice versa).

Processing resource 138 of SDN controller 102 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 140, or suitable combinations thereof. Processing resource 138 can, for example, include single or multiple cores on a chip, multiple cores across multiple chips, multiple cores across multiple devices, or suitable combinations thereof. Processing resource 138 can be functional to fetch, decode, and execute instructions as described herein. As an alternative or in addition to retrieving and executing instructions, processing resource 138 can, for example, include at least one integrated circuit (IC), other control logic, other electronic circuits, or suitable combination thereof that include a number of electronic components for performing the functionality of instructions stored on memory resource 140. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 138 can, for example, be implemented across multiple processing units and instructions may be implemented by different processing units in different areas of SDN controller 102.

Memory resource 140 of SDN controller 102 can, for example, be in the form of a non-transitory machine-readable storage medium, such as a suitable electronic, magnetic, optical, or other physical storage apparatus to contain or store information such as machine-readable instructions 142, 144, and 146. Such instructions can be operative to perform one or more functions described herein, such as those described herein with respect to method 126 or other methods described herein. Memory resource 140 can, for example, be housed within the same housing as processing resource 138 for SDN controller 102, such as within a computing tower case for SDN controller 102 (in implementations where SDN controller 102 is housed within a computing tower case). In some implementations, memory resource 140 and processing resource 138 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 140 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 140 can be in communication with processing resource 138 via a communication link 148. Each communication link 148 can be local or remote to a machine (e.g., a computing device) associated with processing resource 138. Examples of a local communication link 148 can include an electronic bus internal to a machine (e.g., a computing device) where memory resource 140 is one of volatile, non-volatile, fixed, and/or removable storage medium in communication with processing resource 138 via the electronic bus.

In some implementations, one or more aspects of SDN controller 102 (as well as switch 110 or other devices of SDN 100) can be in the form of functional modules that can, for example, be operative to execute one or more processes of instructions 142, 144, or 146 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a network switch 110 can, for example, include one or more machine-readable storage mediums and one or more computer processors.

In view of the above, it is appreciated that the various instructions of SDN controller 102 described above can correspond to separate and/or combined functional modules. For example, instructions 142 can correspond to a “control channel monitoring SDN application module” to run a first SDN application to monitor usage of control channel 108 and instructions 146 can correspond to a “throttling module” to throttle the use of the control channel by the second SDN application. It is further appreciated that a given module can be used for multiple functions. As but one example, in some implementations, a single module can be used to both run SDN applications (e.g., corresponding to the functionality of instructions 142 and 144) as well as to throttling the use of the control channel (corresponding to the functionality of instructions 146).

One or more nodes within SDN 100 (e.g., SDN controller 102, network switch 110, etc.) can further include a suitable communication module to allow networked communication between SDN controller 102, network switch 110, and/or other elements of SDN 100. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of SDN controller 102, network switch 110, or other network equipment. The communication module can, for example, include machine-readable instructions for use with communication the communication module, such as firmware for implementing physical or virtual network ports.

FIG. 7 illustrates a machine-readable storage medium 150 including various instructions that can be executed by a computer processor or other processing resource. In some implementations, medium 150 can be housed within an SDN controller, such as SDN controller 102, or on another computing device within SDN 100 or in local or remote wired or wireless data communication with SDN 100.

For illustration, the description of machine-readable storage medium 150 provided herein makes reference to various aspects of SDN controller 102 (e.g., processing resource 138) and other implementations of the disclosure (e.g., method 126). Although one or more aspects of SDN controller 102 (as well as instructions such as instructions 142, 144, and 146) can be applied or otherwise incorporated with medium 150, it is appreciated that in some implementations, medium 184 may be stored or housed separately from such a system. For example, in some implementations, medium 150 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 150 includes machine-readable instructions 152 stored thereon to cause processing resource 138 to continuously monitor, with a first SDN application, usage of control channel 108 for SDN controller 102 and device (e.g., switch 110 for purposes of illustration in this example). In some implementations, the first and second SDN applications can, for example, run on SDN controller 102. In some implementations the first or second SDN applications or both can be run on another device that interfaces with SDN controller 102. Instructions 152 can, for example, incorporate one or more aspects of block 128 of method 126 or instructions 146 of SDN controller 102 or another suitable aspect of other implementations described herein (and vice versa).

Medium 150 includes machine-readable instructions 154 stored thereon to cause processing resource 138 to determine, with the first SDN application, whether the monitored usage satisfies a usage criteria. Instructions 154 can, for example, incorporate one or more aspects of block 130 of method 126 or instructions 146 of SDN controller 102 or another suitable aspect of other implementations described herein (and vice versa).

Medium 150 includes machine-readable instructions 156 stored thereon to cause processing resource 138 to instruct, with the first SDN application, a second SDN application to limit its usage of the control channel when it is determined that the monitored usage satisfies the usage criteria. Instructions 156 can, for example, incorporate one or more aspects of block 134 of method 126 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
monitoring, with a Software-Defined Network (SDN) controller, usage of a control channel for the SDN controller and a device in the control domain of the SDN controller; and
determining, with the SDN controller, whether the monitored usage satisfies a usage criteria.

2. The method of claim 1, wherein monitoring usage of a control channel includes monitoring a rate of data packets through the control channel.

3. The method of claim 1, wherein monitoring usage of a control channel includes monitoring a data transfer rate through the control channel.

4. The method of claim 1, wherein the usage criteria is based on a packet rate limit for the control channel.

5. The method of claim 1, wherein the usage criteria is based on a data rate limit for the control channel.

6. The method of claim 1, wherein monitoring usage of the control channel includes continuously monitoring usage of the control channel.

7. The method of claim 1, further comprising:
throttling, with the SDN controller, usage of the control channel for an SDN application when it is determined that the monitored usage satisfies the usage criteria.

8. The method of claim 1, further comprising:
instructing, with the SDN controller, an SDN application to limit its usage of the control channel when it is determined that the monitored usage satisfies the usage criteria.

9. The method of claim 8, wherein instructing the SDN application to limit its usage of the control channel includes instructing the SDN application to stop using the control channel for a period of time.

10. The method of claim 1, further comprising:
transmitting, to an SDN application, data relating to the monitored usage.

11. The method of claim 1, wherein the data relating to the monitored usage is an indicator that identifies whether the monitored usage satisfies the usage criteria.

12. A non-transitory machine readable storage medium having stored thereon machine readable instructions to cause a computer processor to:
continuously monitor, with a first Software-Defined Network (SDN) application, usage of a control channel for the SDN controller and a device in the control domain of the SDN controller, wherein the first SDN application is to run on the SDN controller;
determine, with the first SDN application, whether the monitored usage satisfies a usage criteria; and
instruct, with the first SDN application, a second SDN application to limit its usage of the control channel when it is determined that the monitored usage satisfies the usage criteria.

13. The medium of claim 12, wherein the second SDN application is to run on the SDN controller.

14. A Software-Defined Network (SDN) controller comprising:
a processing resource;
a memory resource including machine readable instructions to:
run a first SDN application to monitor usage of a control channel between the SDN controller and a device in the control domain of the SDN controller;
run a second SDN application that uses the control channel to communicate with the device;
throttle the use of the control channel by the second SDN application when it is determined, by monitoring usage of the control channel with the first SDN application, that control channel usage satisfies a usage criteria.

15. The SDN controller of claim 14, wherein the memory resource including machine readable instructions to only throttle the use of the control channel for the second SDN application when the control channel usage satisfies the usage criteria.
